(19) United States
(12) Patent Application Publication
(10) Pub. No.: US 2009/0126874 A1
(43) Pub. Date: May 21, 2009

(54) SUPPLY DEVICE FOR A TIRE-BUILDING DRUM

(75) Inventors: Volker Mehlan, Holzminden (DE); Martin Gerighausen, Barsinghausen (DE)

Correspondence Address: LERNER GREENBERG STEMER LLP, P O BOX 2480, HOLLYWOOD, FL, 33022-2480, US

(73) Assignee: Continental Aktiengesellschaft, Hannover (DE)

(21) Appl. No.: 12/357,739

(22) Filed: Jan. 22, 2009

Related U.S. Application Data
(63) Continuation of application No. PCT/EP2007/054991, filed on May 23, 2007.

(30) Foreign Application Priority Data
Jul. 22, 2006 (DE) 102006033987.8

(51) Int. Cl. B29D 30/08

(52) U.S. Cl. 156/406.4

(57) ABSTRACT

A supply device for a tire-building drum, in particular for a tire-belt drum for building a multilayer tire-belt package for a pneumatic tire, where a plurality of layers of different or differently treated, substantially strip-like pieces of material web are, in succession, placed on, rolled onto, and bonded to one another on the tire-building drum. The supply device has cutting devices in which cut-to-length pieces of material web are formed and then transported to the tire-building drum by a drum supply device, which has two drum feed belts. Two pairs of cutting devices are disposed mutually above one another and assigned to the drum feed belts. The cutting devices are displaceable relative to the drum feed belts such that, in the backward receptive position, the drum feed belts can be brought into active contact in alternation with one of the pairs of cutting devices. The pairs of cutting devices are coupled to advancer belts that are equally arranged in pairs and, together with the cutting devices, can be positioned individually in front of the drum feed belts. The advancer belts and the drum feed belts are laterally moveable with respect to one another.

### CROSS-REFERENCE TO RELATED APPLICATIONS

This is a continuing application, under 35 U.S.C. § 120, of copending international application PCT/EP2007/054991, filed May 23, 2007, which designated the United States; this application also claims the priority, under 35 U.S.C. § 119, of German patent application DE 10 2006 033 987.8, filed Jul. 22, 2006; the prior applications are herewith incorporated by reference in their entirety.

### BACKGROUND OF THE INVENTION

### Field of the Invention

The invention relates to a supply device (i.e., a servicer) for a tire building drum, in particular for a breaker belt drum for building a multi-ply breaker belt assembly of a pneumatic vehicle tire, a number of plies of different or differently treated, substantially strip-like pieces of material web being successively placed on the tire building drum, rolled and bonded to one another;

wherein the supply device has four unwinding stations, guiding devices arranged downstream of the latter for the material webs, as well as feeding and cutting devices assigned to the individual guiding devices for cutting the material webs to length;

wherein the cut pieces of material web can be transported to the tire building drum by way of a drum feeding device, which has two drum feeding belts, the drum feeding belts being displaceable between a backward receiving position and an advanced-forward resting position on the tire building drum; and

wherein the drum feeding belts are assigned two pairs of cutting devices, which are arranged one above the other and can be displaced in relation to the drum feeding belts in such a way that the drum feeding belts in the backward receiving position can be alternately brought into operative connection with one of the pairs of cutting devices.

A supply device of the foregoing type is described in the commonly assigned, published German patent application DE 199 38 151 A1. The feeding and cutting devices that can be brought into operative connection with the drum feeding device, which has two conveyor belts, are arranged one above the other and can be displaced substantially perpendicularly in relation to the drum feeding device. The drum feeding device, or its two conveyor belts, can be displaced into a backward cutting and receiving position for receiving the material webs and during the cutting operation.

Commonly assigned U.S. Pat. No. 6,547,906 B1 and its German counterpart DE 196 41 509 A1 describe an apparatus for conveying and preparing a breaker belt building strip with reinforcing elements, in particular made of steel, which are arranged running parallel, obliquely in relation to the conveying direction, are embedded in rubber and by means of which the cut breaker belt building strip can be transported to a downstream breaker belt building drum. The apparatus has two conveyor belts arranged one behind the other, of which the one that is arranged in front in the conveying direction is formed in such a way that it can be laterally displaced in a controlled manner. A sensor device with at least two sensors for determining the position of the side edges of the breaker belt ply strip is provided. The apparatus also has means for the controlled holding of the front tip of the breaker belt ply strip in the region of the second conveyor belt. The sensor device, the drive means and the means for controlled holding are coupled in such a way that, by lateral displacement of the conveyor belt arranged in front in the conveying direction with respect to the conveyor belt arranged behind, in a first step the front tip of the breaker belt ply strip in the conveying direction can be aligned in its shaping and lateral position, in a second step the main part of the breaker belt ply strip can be aligned center-symmetrically in its shaping and its lateral position, and in a third step the tip pointing counter to the conveying direction is aligned with respect to its shaping and its lateral position.

The prior art therefore discloses on the one hand a supply device with two material feeding belts arranged one behind the other and an aligning device, and on the other hand another supply device with two drum feeding belts and four cutting devices, without any possibility for alignment being provided. The cut material webs must therefore be aligned by the operator on the drum, which involves an increased amount of time being needed for winding the material webs, for example the breaker belt plies. The splicing of the breaker belt plies is also very time-consuming when the ply material is not aligned, due to the resultant inaccuracy of the splice. The accuracy with which the operator works also influences the accuracy with which the breaker belt material is positioned on the drum and the quality of the splice.

### SUMMARY OF THE INVENTION

It is accordingly an object of the invention to provide a supply device in a tire building installation which overcomes the above-mentioned disadvantages of the heretofore-known devices and methods of this general type and which makes it possible in a simple and expedient way to provide devices for aligning the cut material in the context of the above-summarized supply device.

With the foregoing and other objects in view there is provided, in accordance with the invention, a supply device for a tire building drum, comprising:

four unwinding stations for supplying material webs, guiding devices for the material webs disposed downstream of the unwinding stations, and feeding devices and cutting devices assigned to individual the guiding devices for cutting the material webs to length;

a drum feeding device disposed to transport cut-to-length pieces of material web to the tire building drum, the drum feeding device including two drum feeding belts displaceably disposed between a backward receiving position and an advanced-forward resting position on the tire building drum;

wherein the drum feeding belts are assigned two pairs of the cutting devices, the cutting devices of the pairs being disposed one above the other and being displaceable in relation to the drum feeding belts such that the drum feeding belts, in the backward receiving position thereof, are alternately brought into operative connection with one of the pairs of cutting devices;

advancing belts disposed in pairs and coupled to the pairs of cutting devices, wherein the advancing belts can be positioned together with the cutting devices individually in front of the drum feeding belts, and wherein the advancing belts and the drum feeding belts are movable relative to one another in a lateral direction.

In accordance with a particular implementation of the invention, there is provided a servicer for a breaker belt drum for building a multi-ply breaker belt assembly of a pneumatic vehicle tire wherein a number of plies of different or differently treated, substantially strip-like pieces of material web are successively placed on the tire building drum, rolled and bonded to one another.

In other words, the objects of the invention are achieved by the cutting devices that are arranged in pairs being coupled with advancing belts which are equally arranged in pairs and can be positioned together with the cutting devices individually in front of the drum feeding belts, the advancing belts and the drum feeding belts being movable in relation to one another in a lateral direction.

The supply device configured according to the invention may therefore have four cutting devices, which can interact with aligning devices, only two drum feeding belts being required. The alignment in this case takes place by lateral relative movement between the advancing belts and the drum feeding belts. The supply device has a compact type of construction, increases the quality of the splice and the positioning accuracy of the material webs on the drum and, as a result of the increase in the degree of automation, brings about a reduction in the cycle time.

In accordance with an added feature of the invention, the assembly includes sensor devices for sensing a position of end portions and side edges of the pieces of material web, the sensor devices respectively interacting with those pairs of cutting devices and advancing belts that are aligned in relation to said drum feeding belts. That is, the alignment of the material webs can be accomplished particularly easily with the sensor devices for sensing the positions of the end portions and the side edges of the pieces of material web.

In accordance with a concomitant feature of the invention, there is provided a lifting device for moving the cutting devices together with the advancing belts assigned thereto in a vertical direction.

Other features which are considered as characteristic for the invention are set forth in the appended claims.

Although the invention is illustrated and described herein as embodied in supply device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side view of a supply device according to the invention; and

FIG. 2 is a plan view of the supply device according to FIG. 1.

### DETAILED DESCRIPTION OF THE INVENTION

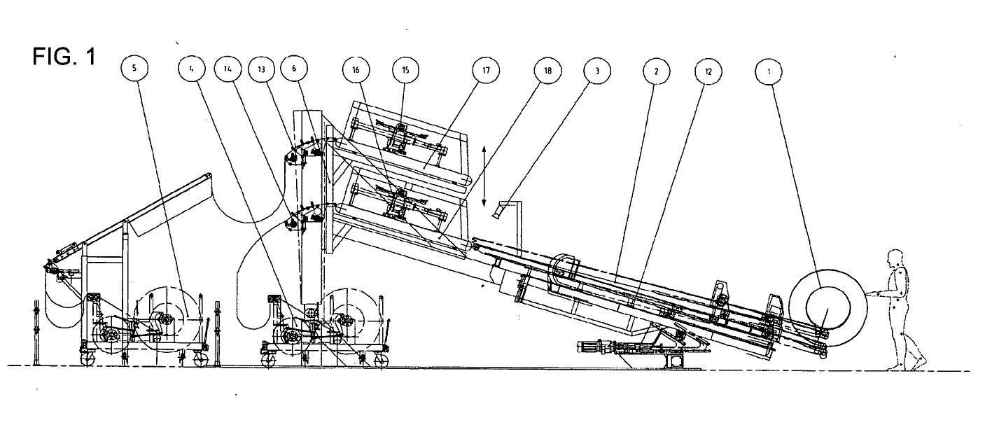

Referring now to the figures of the drawing in detail and first, particularly, to FIG. 1 thereof, the apparatus according to the invention is a supply device—also referred to as a servicer—in which the transfer of the tire component to a tire building drum 1 takes place in a tangential and undershot manner in relation to the circumference of the drum. It is therefore known as a bottom-belt servicer. A supply device configured according to the invention may also be configured as a top-belt servicer, in which the transfer of the tire component to the tire building drum takes place in a tangential and overshot manner in relation to the circumference of the drum.

The tire building drum 1 indicated in FIG. 1 is, in particular, a breaker belt drum for building the breaker belt assembly of a radial pneumatic tire. The breaker belt plies of strip-like parts of material are placed onto a breaker belt drum and rolled. In the case of a car tire, usually two breaker belt plies are bonded to form the breaker belt assembly, in the case of a truck tire it is usually four breaker belt plies. Since the supply device according to the invention can also be used for other tire components, the term material web will be used in the following.

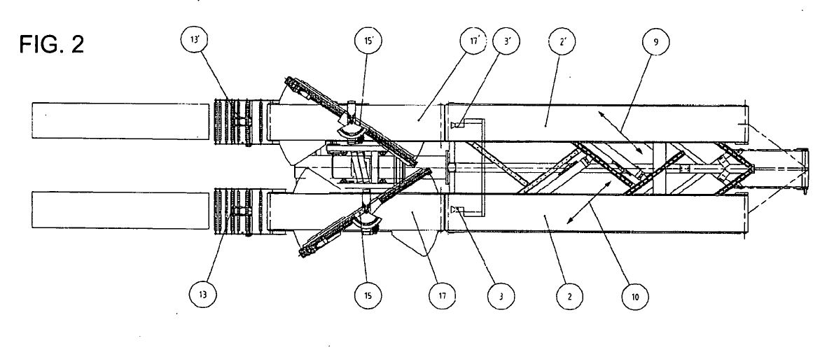

The supply device has a drum feeding device 12, which in the exemplary embodiment comprises two circulating or continuous drum feeding belts 2, 2′. The two drum feeding belts 2, 2′ can, each in themselves, be brought from a backward take-over position, which is shown in FIGS. 1 and 2, into an advanced-forward resting position, which is indicated by dashed lines in the figures and in which the respective drum feeding belt 2, 2′ abuts with its free end against the tire building drum 1 tangentially in the lower region. The two drum feeding belts 2, 2′ are configured in such a length that they can respectively receive the entire tire component in the longitudinal direction. The two drum feeding belts 2, 2′ are also mounted in such a way that they can be displaced by means of a suitable device in their plane and at the same time in the direction of the arrows 9 and 10 (FIG. 2). To be precise each belt 2, 2′ can be displaced on its own. By a tilting movement, each of the drum feeding belts 2, 2′ can be moved with its outer end portion in the direction of the tire building drum 1.

The supply device has four unwinding stations 4, 5, which are respectively arranged in pairs and only two of which can be seen in FIG. 1. The two others are concealed by the unwinding stations 4, 5 that are represented. The unwinding stations 4, 5 contain the rolled-up strip-like material webs for the tire components. The material webs are led to feeding devices 13, 14, 13′, 14′ and cutting devices 15, 16, 15′, 16′ by means of a system comprising rollers and compensating loops. In this case, one pair of cutting devices 15, 15′ and one pair of feeding devices 13, 13′ are arranged or mounted above a further pair of cutting devices 16, 16′ and a further pair of feeding devices 14, 14′ on a lifting device 6 and can be moved up and down by means of the latter in a vertical direction, and consequently with respect to the drum feeding belts 2, 2′. Each cutting device 15, 15′, 16, 16′ is respectively assigned an advancing belt 17, 17′, 18, 18′. The advancing belts 17, 18 can be moved vertically up and down together with the cutting devices 15, 16 and the advancing belts 17′, 18′ can be moved vertically up and down together with the cutting devices 15′, 16′ on the lifting device 6. The advancing belts 17, 17′, 18, 18′ are configured as endless conveyor belts; their alignment with respect to the horizontal corresponds to the alignment of the drum feeding belts 2, 2′. The belts 17, 17′, 18, 18′ can be brought into positions on the lifting device 6 in which their upper sides are in line with the upper belt sides of the drum feeding belts 2, 2′, so that the conveying directions of the advancing belts 17 and 18 can coincide with those of the drum feeding belts 2, 2′.

Individual component parts of the supply device may, where required, be equipped with holding and fixing devices, for example with magnetic plates if the material webs that are handled by means of the supply device contain metallic reinforcing elements.

From the individual unwinding stations 4, 5, the material webs for the tire component, for example the breaker belt ply material for four breaker belt plies, are transported by way of the supply devices 13, 13′, 14, 14′ onto the advancing belts 17, 17′, 18, 18′. The starting material taken from the individual unwinding stations may differ with respect to its configuration, for example its width or the material of the reinforcing elements contained therein. In the position shown in FIG. 1, the two drum feeding belts 2, 2′ are in their backward take-over position, aligned with the two advancing belts 18, 18′. The ends of the fed material webs are appropriately cut by the preceding cutting operation. The fed material webs are transported beyond the two advancing belts 18, 18′ onto the drum feeding belts 2, 2′, until the material running in has reached the intended cut length. Then, the two material webs are severed by means of the cutting devices 16, 16′. This may take place in a known way by means of roller cutters, for example creating a cut edge at an acute angle to the transporting direction. Subsequently, the drum feeding belts 2, 2′ move successively into the advanced-forward delivery position and transfer the cut-to-length tire components to the tire building drum 1. For example, the drum feeding belt 2′ first transfers the piece of material web and is subsequently moved backward again, so that the drum feeding belt 2 can be moved into the delivery position with the piece of material web located on it. In the meantime, the upper pair of advancing belts 17, 17′ are moved together with the assigned cutting devices 15, 15′ into the lower position, so that material webs can then be transported from the advancing belts 17, 17′ onto the feeding belts 2, 2′ and, after the cutting operation, to the drum 1.

The placement of four breaker belt plies, therefore, requires only two drum feeding belts 2, 2′, which respectively interact alternately with the assigned upper and lower advancing belts 17, 17′, 18, 18′ and the cutting devices 15, 15′, 16, 16′. In this way, four different breaker belt plies can be placed in the predetermined sequence on the tire building drum 1.

The side edges of the material webs formed by rubber mixtures and embedded steel cords are not rectilinear but curvilinear in the line said edges follow during the conveyance due to the influence of external forces, it being possible for the curvilinearity of the two side edges to be different, so that the line of center-symmetry between the side edges, running in the conveying direction, may also be a curvilinear curve. Due to the usually oblique cut in relation to the transporting direction, the parts of the material web have triangular end regions. Usually, the front tip in particular is curved, often irregularly, on account of different external force effects and on account of the plastic deformability of the material. When placing such a part of a material web, the irregularities in the line followed by the contour of the side edges and the irregular curvatures in the region of the front and rear tips would have the effect that the ends to be spliced would be offset axially in relation to one another and that there would be no parallel line of contact between the front edge and the rear edge, as a result of which the production of a durable spliced seam may be made more difficult or, in an extreme case, even prevented.

It is therefore provided that the material webs are appropriately aligned when they are transferred from the advancing belt 17, 17′, 18, 18′ onto the drum feeding belts 2, 2′. For this purpose, the advancing belts 17, 17′, 18, 18′ and drum feeding belts 2, 2′ can be moved by a suitable device relative to one another in a lateral direction, transversely in relation to the transporting direction. The process described in U.S. Pat. No. 6,547,906 B1 and DE 196 41 509 A1 is preferably used for this. For the lateral alignment, in a first step the front tip of the material web in the conveying direction is aligned with respect to its shape and its lateral position, subsequently the main part of the material web between the front and rear tips is aligned with respect to its lateral position and finally the rear tip of the piece of material web is also appropriately aligned. Sensors 3, 3′, which are for example CCD cameras, sense the lateral web edges of the material web between the advancing belts 17, 17′, 18, 18′ and the drum feeding belts 2, 2′. The readjustment and alignment of the end tips and the side edges of the cut-to-length piece of material web take place by carrying out a lateral movement of the respective advancing belt 17, 17′, 18, 18′. As this happens, one of the sensors determines the side edge position of the front tip and, on the basis of the side edge position thus determined, the tip is aligned in its position and deformed in such a way that the edge laterally delimiting the material web in the region of the front tip corresponds to a lateral desired edge alignment position and contour. Sensors determining the side edge line followed by the two side edges subsequently bring about an alignment of the main part of the material web by a lateral movement of the advancing belts 17, 17′, 18, 18′, in that the main part is laterally aligned center-symmetrically in relation to its axis in the conveying direction at each position in the conveying direction in the line followed by its two side edges. Finally, the alignment of the rear tip of the piece of material web takes place in an analogous way.

The advancing belts 17, 17′, 18, 18′ therefore allow the alignment of the material webs by their lateral displacement in dependence on the measured orientation of the side edges of the material web during the transfer of the material web to the drum feeding belts 2, 2′.

As already mentioned, the supply device according to the invention is suitable in particular for creating a breaker belt assembly from four breaker belt plies which differ with respect to their width, the angling of their steel cord reinforcing elements and possibly other parameters. The supply device according to the invention may also be intended for forming the breaker belt assembly of car tires, which comprises two breaker belt plies of different widths. With a supply device according to the invention, two differently constructed breaker belts for car tires can be created without having to perform an otherwise necessary change of the supply device.

1. A supply device for a tire building drum, comprising:
four unwinding stations for supplying material webs, guiding devices for the material webs disposed downstream of said unwinding stations, and feeding devices and cutting devices assigned to individual said guiding devices for cutting the material webs to length;
a drum feeding device disposed to transport cut-to-length pieces of material web to the tire building drum, said drum feeding device including two drum feeding belts displaceably disposed between a backward receiving position and an advanced-forward resting position on the tire building drum;
wherein said drum feeding belts are assigned two pairs of said cutting devices, said cutting devices of said pairs being disposed one above the other and being displaceable in relation to said drum feeding belts such that said drum feeding belts, in the backward receiving position thereof, are alternately brought into operative connection with one of said pairs of cutting devices;
advancing belts disposed in pairs and coupled to said pairs of cutting devices, wherein said advancing belts can be positioned together with said cutting devices individually in front of said drum feeding belts, and wherein said advancing belts and said drum feeding belts are movable relative to one another in a lateral direction.

2. The supply device according to claim 1 configured as a servicer for a breaker belt drum for building a multi-ply breaker belt assembly of a pneumatic vehicle tire wherein a number of plies of different or differently treated, substantially strip-like pieces of material web are successively placed on the tire building drum, rolled and bonded to one another.

3. The supply device according to claim 1, which comprises sensor devices for sensing a position of end portions and side edges of the pieces of material web, said sensor devices respectively interacting with those pairs of cutting devices and advancing belts that are aligned in relation to said drum feeding belts.

4. The supply device according to claim 1, which comprises a lifting device for moving said cutting devices together with said advancing belts assigned thereto in a vertical direction.
